(19) United States
(12) Patent Application Publication
(10) Pub. No.: US 2013/0334774 A1
(43) Pub. Date: Dec. 19, 2013

(54) Structure of Titanium-alloy Piston Ring

(71) Applicant: TAI MAO INDUSTRIAL CORP., Tainan City (TW)

(72) Inventor: Wan-Jie Lu, Tainan City (TW)

(73) Assignee: TAI MAO INDUSTRIAL CORP., Tainan City (TW)

(21) Appl. No.: 13/787,954

(22) Filed: Mar. 7, 2013

(30) Foreign Application Priority Data
Jun. 19, 2012 (TW) 101121890

(51) Int. Cl. F16J 9/26

(52) U.S. Cl. CPC F16J 9/26
USPC 277/443; 277/434; 277/440; 277/442

(57) ABSTRACT

A structure of a titanium-alloy piston ring is configured to be installed in an engine and includes a titanium-alloy matrix. The titanium-alloy matrix has an outer periphery receiving a hardening treatment (such as receiving a nitrogen treatment, or being coated with a diamond-like carbon film, or receiving a nitrogen treatment and then being coated with a diamond-like carbon film), so as to make the piston ring have improved abrasion-resistant strength, hardness, and wear resistance, thereby extending the normal service life of the piston ring.

### BACKGROUND OF THE INVENTION

1. Technical Field

The present invention relates to a structure of a titanium-alloy piston ring that is configured to be installed in an engine and has a titanium-alloy matrix. The titanium-alloy matrix has an outer periphery receiving a hardening treatment, so that the piston ring has a substantially extended normal service life.

2. Description of Related Art

The conventional piston for being installed in a vehicle engine typically has two to three serially arranged frictional components (i.e. a compression ring, an oil ring, and a scraper ring, generally known as piston rings). Therein, the scraper ring is in the shape of a thin ring and is mounted around the piston to closely contact the inner wall of the cylinder, so as to prevent the engine oil within the cylinder from upward flowing to the combustion chamber. The inner wall of the cylinder is covered by a layer of oil that is supplied by the oil ring. During air intake and power stroke of the engine, the scraper ring serves to remove exceeding engine oil from the inner wall of the cylinder. The existing scraper ring, however, is limited in the overall structural strength and elasticity, so it tends to get worn out prematurely and has a reduced service life. When the scraper ring having such poor structural strength and elasticity and coming without any special surface treatment is worn after a period of use, the consumption of engine oil is increased, meaning that the engine starts to waste engine oil. In addition, poor air-tightness of the piston can decrease the combustion efficiency, and in a worse case, the piston can move unstably, thereby hindering the engine from supplying power smoothly.

### SUMMARY OF THE INVENTION

The present invention hence provides further improvements to the piston ring used in an engine, with the attempt to substantially extend the normal service life of the piston ring by making the piston ring of titanium alloy, and performing a hardening treatment on the outer periphery of the titanium-alloy matrix during manufacturing.

A first primary objective of the present invention is to provide a structure of a titanium-alloy piston ring, being configured to be installed in an engine and having a titanium-alloy matrix.

A second primary objective of the present invention is to provide a structure of a titanium-alloy piston ring, being configured to be installed in an engine and having a titanium-alloy matrix that has an outer periphery previously receiving a hardening treatment during manufacturing thereof, so as to make the piston ring have substantially improved wear resistance and an extended normal service life.

A third primary objective of the present invention is to provide a structure of a titanium-alloy piston ring, being configured to be installed in an engine and having a titanium-alloy matrix that has an outer periphery previously being coated by a diamond-like carbon film during manufacturing thereof, so as to make the piston ring have substantially improved abrasion-resistant strength, hardness and wear resistance and an extended normal service life.

A fourth primary objective of the present invention is to provide a structure of a titanium-alloy piston ring, having a titanium-alloy matrix that has an outer periphery previously receiving a nitrogen treatment and then being coated by a diamond-like carbon film during manufacturing thereof, so as to make the piston ring have substantially improved abrasion-resistant strength, hardness and wear resistance, thereby extending a normal service life of the piston ring.

### BRIEF DESCRIPTION OF THE DRAWINGS

The invention as well as a preferred mode of use, further objectives and advantages thereof will be best understood by reference to the following detailed description of illustrative embodiments when read in conjunction with the accompanying drawings, wherein:

FIG. 1 is a perspective view of a piston ring according to the present invention;

FIG. 2 is a schematic cross-sectional drawing showing the piston ring of the first embodiment of the present invention installed in a cylinder and contacting an inner wall of the cylinder;

FIG. 3 is a schematic cross-sectional drawing showing the piston ring of the second embodiment of the present invention installed in a cylinder and contacting an inner wall of the cylinder; and

FIG. 4 is a schematic cross-sectional drawing showing the piston ring of the third embodiment of the present invention installed in a cylinder and contacting an inner wall of the cylinder.

### DETAILED DESCRIPTION OF THE INVENTION

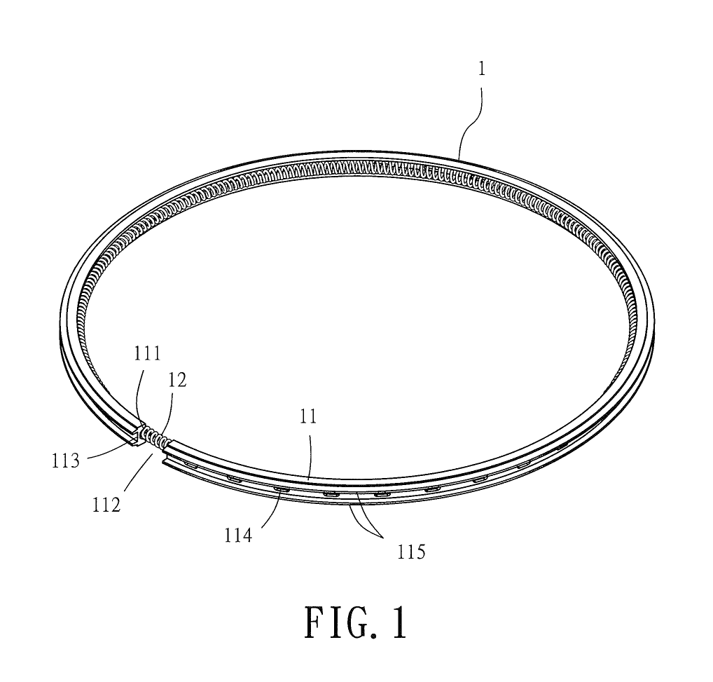

According to the present invention, a structure of a titanium-alloy piston ring (as shown in FIG. 1) primarily has the piston ring (1) (herein realized by a scraper ring) to be installed in an engine. The piston ring (1) includes a ring body (11) and a spring (12). The coil spring (12) is closely fit in a positioning portion (111) formed on the ring body (11). With an extendable gap (112) provided at one segment of the ring body (11), the spring (12) can be stably positioned along an inner periphery of the ring body (11). A peripheral groove (113) is formed along an outer periphery of the ring body (11), and a plurality of through holes (114) is made at the bottom of the peripheral groove (113). The peripheral groove (113) is defined by two retaining flanges (115) running along its outer periphery, so that the piston ring (1) has a light overall weight, a small friction coefficient, and close contact with the inner wall of the cylinder.

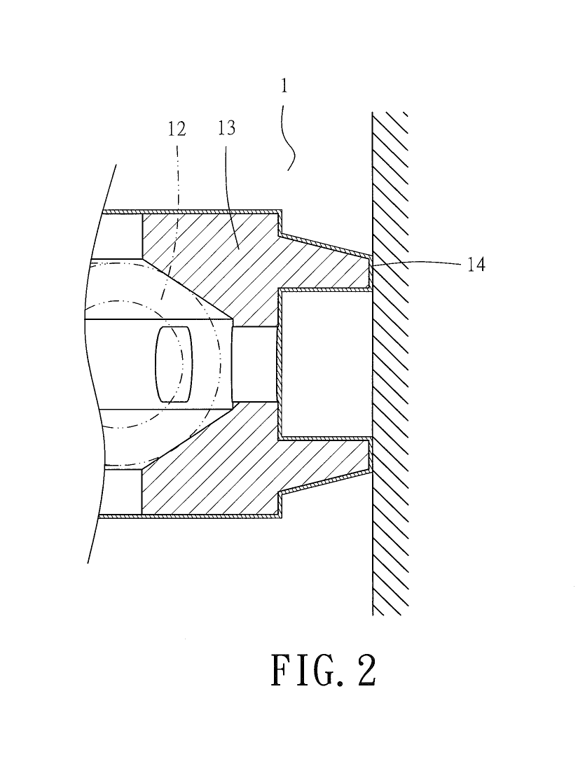

The improvement enabled by the present invention is that, the piston ring (1) (as shown in FIG. 2) has a titanium-alloy matrix (13) whose outer periphery has previously received a nitrogen treatment (14), so that the resulting piston ring (1), in use, exhibits substantially improved wear resistance, and has an extended normal service life.

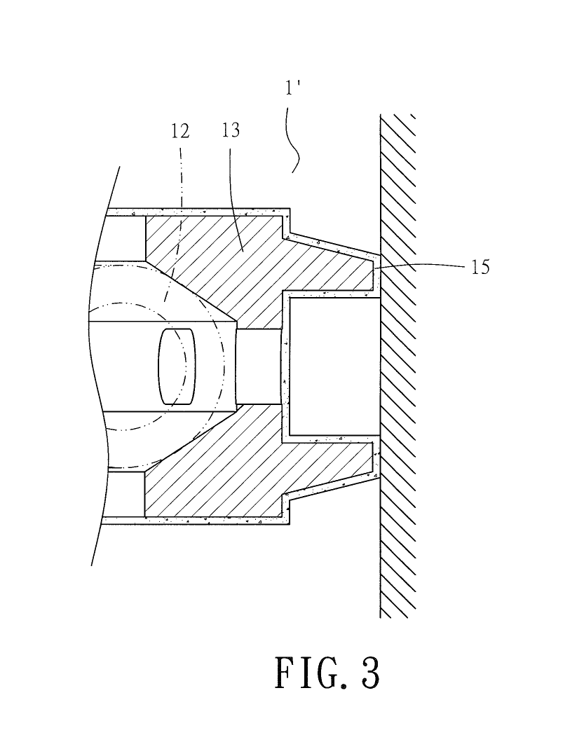

In a second embodiment of the present invention, as shown in FIG. 3, the piston ring (1′) (also realized by a scraper ring) is to be installed in an engine and has a titanium-alloy matrix (13). The titanium-alloy matrix (13) has its outer periphery coated with a diamond-like carbon film (15), so that the resulting piston ring (1′) can show substantially improved abrasion-resistant strength, hardness and wear resistance in use, and has an extended normal service life.

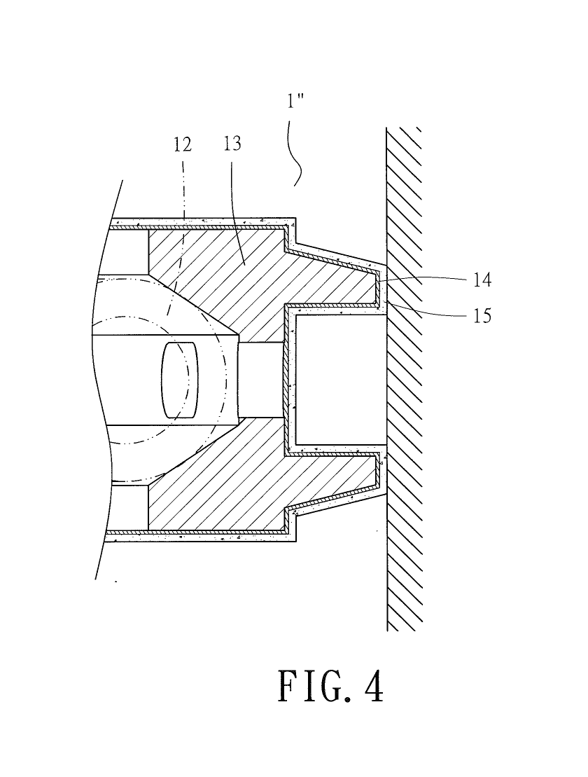

In a third embodiment of the present invention, as shown in FIG. 4, the piston ring (1″) (also realized by a scraper ring) is to be installed in an engine and has a titanium-alloy matrix (13). The titanium-alloy matrix (13) has its outer periphery receiving a nitrogen treatment (14) and then getting coated by a diamond-like carbon film (15) during its manufacturing, so that the resulting piston ring (1″) can show substantially improved abrasion-resistant strength, hardness and wear resistance in use, thereby extending a normal service life of the piston ring (1″).

What is claimed is:

1. A structure of a titanium-alloy piston ring, being configured to be installed in an engine and comprising a titanium-alloy matrix.

2. A structure of a titanium-alloy piston ring, comprising a titanium-alloy matrix that has an outer periphery previously receiving a hardening treatment during manufacturing thereof, so as to make the piston ring have substantially improved wear resistance and an extended normal service life.

3. A structure of a titanium-alloy piston ring, comprising a titanium-alloy matrix that has an outer periphery previously being coated by a diamond-like carbon film during manufacturing thereof, so as to make the piston ring have substantially improved abrasion-resistant strength, hardness and wear resistance and an extended normal service life.

4. A structure of a titanium-alloy piston ring, comprising a titanium-alloy matrix that has an outer periphery previously receiving a nitrogen treatment and then being coated by a diamond-like carbon film during manufacturing thereof, so as to make the piston ring have substantially improved abrasion-resistant strength, hardness and wear resistance, thereby extending a normal service life of the piston ring.
